(19) United States
(12) Patent Application Publication
(10) Pub. No.: US 2023/0031605 A1
(43) Pub. Date: Feb. 2, 2023

(54) COVERS FOR ELECTRONIC DEVICES

(71) Applicant: Hewlett-Packard Development Company, L.P., Spring, TX (US)

(72) Inventors: Kuan-Ting Wu, Taipei City (TW); Chi Hao Chang, Taipei City (TW); Chien-Ting Lin, Taipei City (TW)

(73) Assignee: Hewlett-Packard Development Company, L.P., Spring, TX (US)

(21) Appl. No.: 17/788,361

(22) PCT Filed: Jan. 8, 2020
(86) PCT No.: PCT/US2020/012749

§ 371 Date: Jun. 23, 2022

(51) Int. Cl. C25D 11/30; H04M 1/02; C25D 11/02; C25D 11/24

(52) U.S. Cl. CPC C25D 11/30; H04M 1/0202; C25D 11/026; C25D 11/243

(57) ABSTRACT

This application describes covers for electronic devices, electronic devices, and methods for making the covers. In one example, described herein is a cover for an electronic device comprising: a substrate comprising a metal; a passivation layer or a micro-arc oxidation layer deposited on at least one surface of the substrate; a primer coating layer on the passivation layer or the micro-arc oxidation layer; an optional base coating layer on the primer coating layer; a top coating layer on the optional base coating layer or on the primer coating layer; and a hydrophobic coating layer.

### BACKGROUND

The use of personal electronic devices of all types continues to increase. Cellular phones, including smartphones, have become nearly ubiquitous. Tablet computers have also become widely used in recent years. Portable laptop computers continue to be used by many for personal, entertainment, and business purposes. For portable electronic devices in particular, much effort has been expended to make these devices more useful and more powerful while at the same time making the devices smaller, lighter, and more durable. The aesthetic design of personal electronic devices is also of concern in this competitive market. Devices such as mobile phones, tablets and portable computers are generally provided with a casing. The casing typically provides a number of functional features e.g., protecting the device from damage.

### BRIEF DESCRIPTION OF THE DRAWING

FIG. 1 is a cross-sectional view illustrating an example cover for an electronic device in accordance with examples of the present disclosure;

FIG. 2 is a cross-sectional view illustrating an example cover for an electronic device in accordance with examples of the present disclosure;

FIG. 3 is a cross-sectional view illustrating an example cover for an electronic device in accordance with examples of the present disclosure;

FIG. 4 is a cross-sectional view illustrating an example cover for an electronic device in accordance with examples of the present disclosure; and

FIG. 5 is a flowchart illustrating an example method of making a cover for an electronic device in accordance with examples of the present disclosure.

### DETAILED DESCRIPTION

In some examples, described herein is a cover for an electronic device comprising: a substrate comprising a metal; a passivation layer or a micro-arc oxidation layer deposited on at least one surface of the substrate; a primer coating layer on the passivation layer or the micro-arc oxidation layer; an optional base coating layer on the primer coating layer; a top coating layer on the optional base coating layer or on the primer coating layer; and a hydrophobic coating layer.

In some examples, the metal comprises aluminum and aluminum alloys, titanium and titanium alloys, stainless steel, magnesium and magnesium alloys, aluminum and aluminum alloys, lithium and lithium alloys, and combinations thereof.

In some examples, the top coating layer comprises acrylate epoxy, acrylate urethane, acrylate polyether, acrylate polyester, polyester, polyurethane, and combinations thereof.

In some examples, the top coating layer comprises nanosized and/or coarse high refractive index pigments having a Mohs hardness of about ≥5.

In some examples, the primer coating layer and the base coating layer can comprise polyurethane, silicone-polyurethane copolymer, polyurethane-polystyrene copolymer, polyurethane based copolymers, polyester, epoxy, epoxy-polyester, and combinations thereof.

In some examples, the hydrophobic coating layer has a thickness of from about 10 nm to about 100 nm.

In some examples, the primer coating layer has thickness of from about 5 μm to about 20 μm.

In some examples, the passivation layer has a thickness of from about 1 μm to about 5 μm.

In some examples, the micro-arc oxidation layer has a thickness of from about 3 μm to about 15 μm.

In some examples, the hydrophobic coating layer is selected from the group consisting of silanes, fluorinated olefin-based polymers, specialty fluoroacrylates, fluorosilicone acrylates, fluorourethanes, perfluoropolyethers, perfluoropolyoxetanes, fluorotelomers, polytetrafluoroethylene, polyvinylidenefluouride, fluorosiloxane, fluoro UV polymers, and combinations thereof.

In some examples, disclosed herein is an electronic device comprising: an electronic component; and a cover enclosing the electronic component, the cover comprising: a substrate comprising a metal; a passivation layer or a micro-arc oxidation layer deposited on at least one surface of the substrate; a primer coating layer on the passivation layer or the micro-arc oxidation layer; an optional base coating layer on the primer coating layer; a top coating layer on the optional base coating layer or on the primer coating layer and a hydrophobic coating layer.

In some examples, the electronic device is a laptop, a desktop computer, a keyboard, a mouse, a smartphone, a tablet, monitor, a television screen, a speaker, a game console, a video player, an audio player, or a combination thereof.

In some examples, the hydrophobic coating layer is selected from the group consisting of silanes, fluorinated olefin-based polymers, specialty fluoroacrylates, fluorosilicone acrylates, fluorourethanes, perfluoropolyethers, perfluoropolyoxetanes, fluorotelomers, polytetrafluoroethylene, polyvinylidenefluouride, fluorosiloxane, fluoro UV polymers, and combinations thereof; and the hydrophobic coating layer has a thickness of from about 10 nm to about 100 nm.

In some examples, disclosed herein is a method of making a cover for an electronic device comprising: applying a passivation layer or forming a micro-arc oxidation layer deposited on at least one surface of a substrate; applying a primer coating layer on the passivation layer or the micro-arc oxidation layer; applying an optional base coating layer on the primer coating layer; applying a top coating layer on the optional base coating layer or on the primer coating layer; and applying a hydrophobic coating layer on the top coating layer.

In some examples, the substrate comprises at least one metal, wherein the metal comprises aluminum and aluminum alloys, titanium and titanium alloys, stainless steel, magnesium and magnesium alloys, aluminum and aluminum alloys, lithium and lithium alloys, and combinations thereof.

It is noted that when discussing the cover, the electronic device, or the method of manufacturing the cover, such discussions of one example are to be considered applicable to the other examples, whether or not they are explicitly discussed in the context of that example. Thus, in discussing a metal alloy in the context of the cover, such disclosure is also relevant to and directly supported in the context of the electronic device, the method of manufacturing the multi-color electronic housing, and vice versa.

### Covers for Electronic Devices

The present disclosure describes covers for electronic devices that can be strong and lightweight and have a decorative appearance. The cover can provide an enclosure for an electronic device and the enclosure can include a substrate. The substrate can comprise a metal. The metals used for the substrate may be a light metals. The term “light metal” refers to metals and alloys that are generally any metal of relatively low density including metal that is less than about 5 g/cm³ in density. In some cases, light metal can be a material including aluminum, magnesium, titanium, lithium, zinc, and alloys thereof. These light metals can have useful properties, such as low weight, high strength, and an appealing appearance. However, some of these metals can be easily oxidized at the surface, and may be vulnerable to corrosion or other chemical reactions at the surface. For example, magnesium or magnesium alloys in particular can be used to form covers for electronic devices because of the low weight and high strength of magnesium. Magnesium can have a somewhat porous surface that can be vulnerable to chemical reactions and corrosion at the surface. In some examples, magnesium or magnesium alloy can be treated by micro-arc oxidation to form a layer of protective oxide at the surface. With this example in mind, it is understood that magnesium alloy may be described herein as a class of alloys in some detail by way of example for convenience, but it is also understood that other light metal substrates can be freely substituted for the magnesium alloy examples herein with respect to the covers, electronic devices, and methods herein.

Using magnesium or magnesium alloy as an example class of metal substrates that can be used, this material can form a protective oxide layer that can increase the chemical resistance, hardness, and durability of the magnesium or magnesium alloy. However, micro-arc oxidation (MAO) can also create a dull appearance instead of the original luster of the metal. In other examples, as an alternative to the MAO the magnesium or magnesium alloy can be treated using a passivation layer. The passivation layer for the protective coating may be opaque or transparent and may include molybdates, vanadates, phosphates, chromates, stannates, manganese salts, or a combination thereof. The passivation layer may be about 1 μm to about 5 μm thick.

The present disclosure describes covers for electronic devices that can utilize the above metals for their favorable properties and at the same time the metals can be protected from corrosion. Furthermore, the covers can have an attractive appearance. In some cases, it can be desirable to chamfer certain edges of the cover for ergonomics and/or to enhance the appearance of the cover. Some examples of edges that may be chamfered can include an edge surrounding a track pad on a laptop, an edge surrounding a fingerprint scanner, an outer edge of a smartphone housing, and so on. The covers described herein can include a chamfered edge that can have a customized appearance such as a metallic luster appearance, a colored metallic luster appearance, or an opaque colored appearance.

In certain examples, the cover can have a protective coating such as a MAO layer or a passivation layer and a second protective coating such as a paint coating. The chamfer may be accomplished using computer numeric control (CNC) or laser engraving.

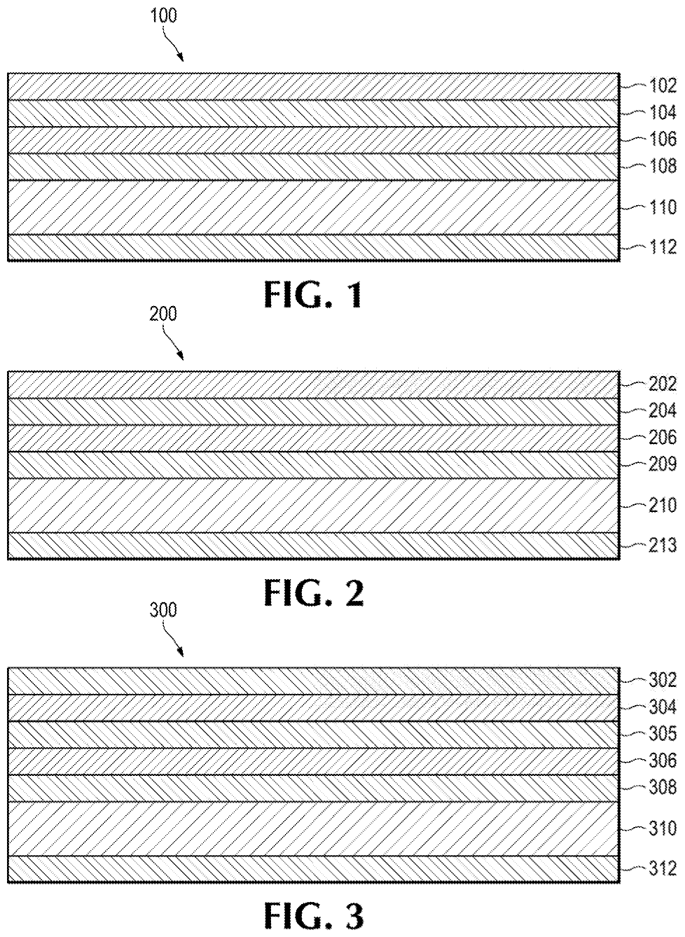

FIG. 1 shows an example cover 100 for an electronic device. The cover 100 includes a substrate 110 with a micro-arc oxidation layer 112 on the bottom surface of the substrate 110 and another micro-arc oxidation layer 108 on the top surface of the substrate 110. Then there is a primer layer 106 on top of the micro-arc oxidation layer 108. Then there is a top coat layer 104 on top of the primer layer 106. Then finally there is a hydrophobic coating 102 on top of the top coat layer 104.

FIG. 2 shows an example cover 200 for an electronic device. The cover 200 includes a substrate 210 with a passivation layer 213 on the bottom surface of the substrate 210 and another passivation layer 209 on the top surface of the substrate 210. Then there is a primer layer 206 on top of the passivation layer 209. Then there is a top coat layer 204 on top of the primer layer 206. Then finally there is a hydrophobic coating 202 on top of the top coat layer 204.

FIG. 3 shows an example cover 300 for an electronic device. The cover 300 includes a substrate 310 with a micro-arc oxidation layer 312 on the bottom surface of the substrate 310 and another micro-arc oxidation layer 308 on the top surface of the substrate 310. Then there is a primer layer 306 on top of the micro-arc oxidation layer 308. Then there is a base coat 305 on top of the primer layer 306 and then a top coat layer 304 on top of the base coat 305. Then finally there is a hydrophobic coating 302 on top of the top coat layer 304.

FIG. 4 shows an example cover 400 for an electronic device. The cover 400 includes a substrate 410 with a passivation layer 413 on the bottom surface of the substrate 410 and another passivation layer 409 on the top surface of the substrate 410. Then there is a primer layer 406 on top of the passivation layer 409. Then there is a base coat 405 on top of the primer layer 406 and then a top coat layer 404 on top of the base coat 405. Then finally there is a hydrophobic coating 402 on top of the top coat layer 404.

In the above examples, an edge of the covers 100, 200, 300, and/or 400 can be chamfered by cutting away material along a 90° angled edge of substrate at about a 45° angle so that the 90° edge is replaced by a sloped surface at about 45°. Accordingly, as used herein, “chamfer” refers to the action of cutting away an edge where two faces meet to form a sloping face transitioning between the two original faces. In some cases, the term “chamfered edge” can refer to the entire transition area between the original faces and the metal at the edge before chamfering together with the sloped face created by the chamfering. In other cases, the term “chamfered edge” may refer specifically to the sloped face created by the chamfering. In many cases, the original edge can be a 90° angle edge, and the chamfer can create a sloping face at about a 45° angle. However, in some examples the original edge can have a different angle and the chamfer can create a sloping surface with a different angle. The chamfer can be performed using CNC techniques, laser engraving, or laser trimming. In further examples, chamfering can be performed using a milling machine with a cutting bit oriented to cut away the edge and create the sloped surface of the chamfered edge. In other examples, the chamfer can be performed by laser cutting, water jet cutting, sanding, or any other suitable method.

As used herein, “cover” refers to the exterior shell of an electronic device that includes or is in the form of an enclosure, and a portion thereof (or the structure thereof) includes a substrate. In other words, the cover can be adapted to contain the internal electronic components of the electronic device. The cover can be an integral part of the electronic device. The term “cover” is not meant to refer to the type of removable protective cases that are often purchased separately for an electronic device (especially smartphones and tablets) and placed around the exterior of the electronic device. Covers as described herein can be used on a variety of electronic devices. For example, a laptop, a desktop, a keyboard, a mouse, a printer, a smartphone, a tablet, a monitor, a television, a speaker, a game console, a video player, an audio player, or a combination thereof. In various examples, the light metal substrate for these covers can be formed by molding, casting, machining, bending, working, stamping, or another process.

In one example, a light metal substrate can be milled from a single block of metal. In other examples, the cover can be made from multiple panels. For example, laptop covers sometimes include four separate cover pieces forming the complete cover of the laptop. The four separate pieces of the laptop cover are often designated as cover A (back cover of the monitor portion of the laptop), cover B (front cover of the monitor portion), cover C (top cover of the keyboard portion) and cover D (bottom cover of the keyboard portion). Covers can also be made for smartphones and tablet computers with a single metal piece or multiple metal panels.

As used herein, a layer that is referred to as being “on” a lower layer can be directly applied to the lower layer, or an intervening layer or multiple intervening layers can be located between the layer and the lower layer. Generally, a layer that is “on” a lower layer can be located further from the substrate. Thus, a “higher” layer applied “on” a “lower” layer may be located farther from the substrate and closer to a viewer viewing the cover from the outside.

It is noted that when discussing covers for electronic devices, the electronic devices themselves, or methods of making covers for electronic devices, such discussions can be considered applicable to one another whether or not they are explicitly discussed in the context of that example. Thus, for example, when discussing the metals used in the light metal substrate in the context of one of the example covers, such disclosure is also relevant to and directly supported in the context of the electronic devices and/or methods, and vice versa. It is also understood that terms used herein will take on their ordinary meaning in the relevant technical field unless specified otherwise. In some instances, there are terms defined more specifically throughout or included at the end of the present disclosure, and thus, these terms are supplemented as having a meaning described herein.

### Electronic Devices

A variety of electronic devices can be made with the covers described herein. In various examples, such electronic devices can include various electronic components enclosed by the cover. As used herein, “encloses” or “enclosed” when used with respect to the covers enclosing electronic components can include covers completely enclosing the electronic components or partially enclosing the electronic components. Many electronic devices include openings for charging ports, input/output ports, headphone ports, and so on. Accordingly, in some examples the cover can include openings for these purposes. Certain electronic components may be designed to be exposed through an opening in the cover, such as display screens, keyboard keys, buttons, track pads, fingerprint scanners, cameras, and so on. Accordingly, the covers described herein can include openings for these components. Other electronic components may be designed to be completely enclosed, such as motherboards, batteries, sim cards, wireless transceivers, memory storage drives, and so on. Additionally, in some examples a cover can be made up of two or more cover sections, and the cover sections can be assembled together with the electronic components to enclose the electronic components. As used herein, the term “cover” can refer to an individual cover section or panel, or collectively to the cover sections or panels that can be assembled together with electronic components to make the complete electronic device.

In further examples, the electronic device can be a laptop, a desktop, a keyboard, a mouse, a printer, a smartphone, a tablet, a monitor, a television, a speaker, a game console, a video player, an audio player, or a variety of other types of electronic devices.

### Methods of Making Covers for Electronic Devices

In some examples, the covers described herein can be made by first forming the substrate. This can be accomplished using a variety of processes, including molding, insert molding, forging, casting, machining, stamping, bending, working, and so on. The substrate can be made from a variety of metals or other materials. In one example, sheet or forge metal is insert molded into the shape of a cover. The metal for the substrate may be aluminum, magnesium, lithium, titanium, and alloys thereof. As mentioned above, in some examples the substrate can be a single piece while in other examples the substrate can include multiple pieces that each make up a portion of the cover. Additionally, in some examples the substrate can be a composite made up of multiple metals combined, such as having layers of multiple different metals, other materials, or panels or other portions of the substrate being different metals or other materials.

Chamfered edges can be formed on an edge of the light metal substrate. In various examples, chamfered edges can be formed at any edge or combination of edges on the cover. The chamfered edge can vary in depth. The term “depth” of chamfered edges refers to the amount of the edge that is cut away by the chamfering process. The depth of the chamfer can be stated in terms of the distance from the or edge of the cover to the edge of the sloped surface created by the chamfering. In various examples, the chamfer can be from about 0.1 mm to about 1 cm deep. In other examples, the chamfer can be from about 0.2 mm to about 5 mm deep. As stated above, in some examples the chamfer can be symmetrical so that the same amount of material is removed on both faces of the cover that meet at the chamfered edge. In a symmetrical chamfering of a 90° edge, the new sloped surface created by the chamfering is at a 45° angle with respect to the original faces of the cover. However, in other examples, the chamfer can be asymmetrical so that the angle of the sloped surface is different with respect to each of the original faces of the cover. The examples of the depth of the chamfer described above can refer to either side of the chamfer in the case of an asymmetrical chamfer.

A chamfered edge can be formed using any suitable process that can remove material at the edge of the cover and produce a sloped surface in place of the original edge. In some examples, the chamfer can be formed using a CNC machine such as a milling machine, a router, a laser engraver, a laser cutter, a water jet cutter, a sander, a file, or other methods.

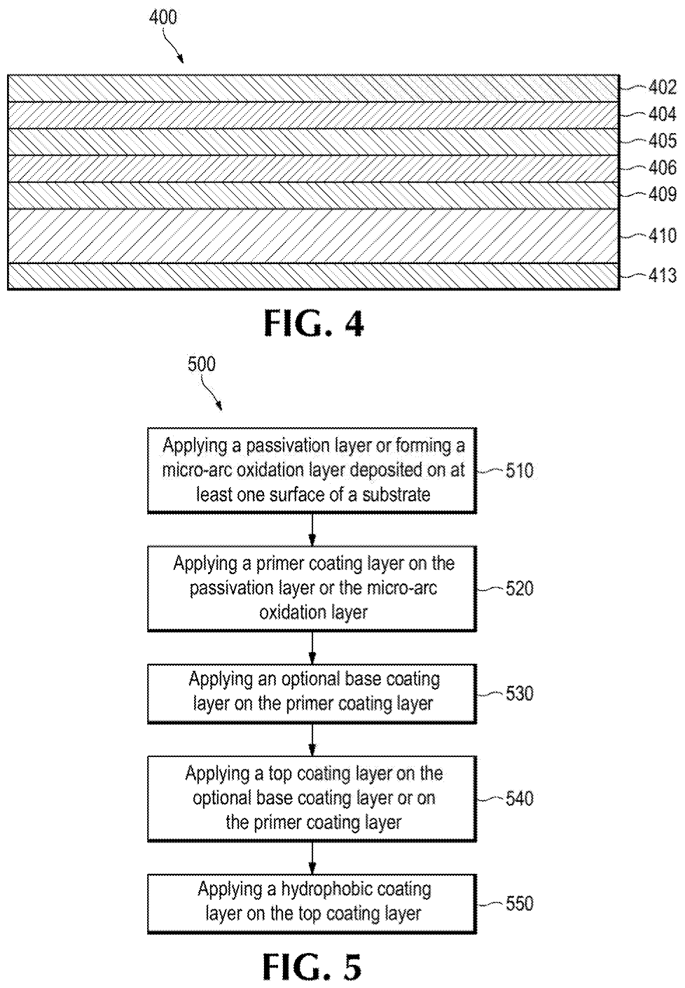

FIG. 5 is a flowchart illustrating an example method 500 of making a cover for an electronic device. The method includes applying a passivation layer or forming a micro-arc oxidation layer deposited on at least one surface of a substrate—510; applying a primer coating layer on the passivation layer or the micro-arc oxidation layer—520; applying an optional base coating layer on the primer coating layer—530; applying a top coating layer on the optional base coating layer or on the primer coating layer—540; and applying a hydrophobic coating layer on the top coating layer—550.

### Substrates for Electronic Device Covers

The substrate can be made from a metal or combination of metals. The substrate may be a single metal, a metallic alloy, a combination of sections made from multiple metals, or in some examples a combination of metal and other materials. In certain examples, the substrate can include metal, a carbon fiber, a plastic, a ceramic, an alloy thereof, or a composite thereof.

The metal for the substrate may be aluminum, magnesium, lithium, titanium, and alloys thereof. Non-limiting examples of elements that an be included in aluminum or magnesium alloys can include aluminum, magnesium, titanium, lithium, niobium, zinc, bismuth, copper, cadmium, iron, thorium, strontium, zirconium, manganese, nickel, lead, silver, chromium, silicon, tin, gadolinium, yttrium, calcium, antimony, cerium, lanthanum, or others.

In some examples, the substrate can include an aluminum magnesium alloy made up of about 0.5% to about 13% magnesium by weight and 87% to 99.5% aluminum by weight. Examples of specific aluminum magnesium alloys can include 1050, 1060, 1199, 2014, 2024, 2219, 3004, 4041, 5005, 5010, 5019, 5024, 5026, 5050, 5052, 5056, 5059, 5083, 5086, 5154, 5182, 5252, 5254, 5356, 5454, 5456, 5457, 5557, 5652, 5657, 5754, 6005, 6005A, 6060, 6061, 6063, 6066, 6070, 6082, 6105, 6162, 6262, 6351, 6463, 7005, 7022, 7068, 7072, 7075, 7079, 7116, 7129, and 7178.

In further examples, the substrate can include magnesium metal, a magnesium alloy that can be about 99 wt % or more magnesium by weight, or a magnesium alloy that is from about 50 wt % to about 99 wt % magnesium by weight. In a particular example, the substrate can include an alloy including magnesium and aluminum. Examples of magnesium-aluminum alloys can include alloys made up of from about 91% to about 99% magnesium by weight and from about 1% to about 9% aluminum by weight, and alloys made up of about 0.5% to about 13% magnesium by weight and 87% to 99.5% aluminum by weight. Specific examples of magnesium-aluminum alloys can include AZ63, AZ81, AZ91, AM50, AM60, AZ31, AZ61, AZ80, AE44, AJ62A, ALZ391, AMCa602, LZ91, and Magnox.

The substrate can be shaped to fit any type of electronic device, including the specific types of electronic devices described herein. In some examples, the substrate can have any thickness suitable for a particular type of electronic device. The thickness of the metal in the substrate can be selected to provide a desired level of strength and weight for the cover of the electronic device. In some examples, the substrate can have a thickness from about 0.5 mm to about 2 cm, from about 1 mm to about 1.5 cm, from about 1.5 mm to about 1.5 cm, from about 2 mm to about 1 cm, from about 3 mm to about 1 cm, from about 4 mm to about 1 cm, or from about 1 mm to about 5 mm, though thicknesses outside of these ranges can be used.

### Protective Coatings for Electronic Device Covers

In one example, a protective coating can be applied to the substrate and can be a micro-arc oxidation layer on a surface thereof. Micro-arc oxidation, also known as plasma electrolytic oxidation, is an electrochemical process where the surface of a metal is oxidized using micro-discharges of compounds on the surface of the substrate when immersed in a chemical or electrolytic bath, for example. The electrolytic bath may include predominantly water with about 1 wt % to about 5 wt % electrolytic compound(s), e.g., alkali metal silicates, alkali metal hydroxide, alkali metal fluorides, alkali metal phosphates, alkali metal aluminates, the like, or a combination thereof. The electrolytic compounds may likewise be included at from about 1.5 wt % to about 3.5 wt %, or from about 2 wt % to about 3 wt %, though these ranges are not considered limiting. In one example, a high-voltage alternating current can be applied to the substrate to create plasma on the surface of the substrate. In this process, the substrate can act as one electrode immersed in the electrolyte solution, and the counter electrode can be any other electrode that is also in contact with the electrolyte. In some examples, the counter electrode can be an inert metal such as stainless steel. In certain examples, the bath holding the electrolyte solution can be conductive and the bath itself can be used as the counter electrode. A high direct current or alternating voltage can be applied to the substrate and the counter electrode. In some examples, the voltage can be about 200 V or higher, such as about 200 V to about 600 V, about 250 V to about 600 V, about 250 V to about 500 V, or about 200 V to about 300 V. Temperatures can be from about 20° C. to about 40° C., or from about 25° C. to about 35° C., for example, though temperatures outside of these ranges can be used. This process can oxidize the surface to form an oxide layer from the substrate material. Various metal or metal alloy substrates can be used, including aluminium, titanium, lithium, magnesium, and/or alloys thereof, for example. The oxidation can extend below the surface to form thick layers, as thick as 30 μm or more. In some examples the oxide layer can have a thickness from about 1 μm to about 25 μm, from about 1 μm to about 22 μm, or from about 2 μm to about 20 μm. Thickness can likewise be from about 2 μm to about 15 μm, from about 3 μm to about 10 μm, or from about 4 μm to about 7 μm. The oxide layer can, in some instances, enhance the mechanical, wear, thermal, dielectric, and corrosion properties of the substrate. The electrolyte solution can include a variety of electrolytes, such as a solution of potassium hydroxide. In some examples, the substrate can include a micro-arc oxidation layer on one side, or on both sides.

In an alternative example, the protective coating is an opaque passivation layer. The passivation layer may refer to a layer or coating over the substrate. Passivation may refer to the use of a light coat of a protective material, such as metal oxide, to create a shell against corrosion. Chemicals may be applied to the surface of the substrate to induce the passivation layer. For example, the chemicals may include at least one of molybdates, vanadates, phosphates, chromates, stannates and manganese salts. The passivation layer may have a thickness of 1-5 μm.

In further examples, a passivation treatment can be used to form a transparent passivation layer as the protective coating. It is noted that the transparent passivation layer is described as a layer for convenience, and thus, can be in the form of a layer. However, the term “passivation layer” also includes metal surface treatment of the exposed metal substrate. In some examples, the transparent passivation layer can include a chelating agent and a metal ion or a chelated metal complex thereof, wherein the metal ion is an aluminum ion, an indium ion, a nickel ion, a chromium ion, a tin ion, or a zinc ion. In certain examples, passivation treatment can be applied at a pH from about 2 to about 6. In a particular example, the pH can be about 2.5 to about 3.5. In further examples, the transparent passivation layer can include an oxide of one of these metals. In some cases, various contaminants can be present on the surface of the light metal substrate. The chelating agent can chelate such contaminants and prevent the contaminants from attaching to the surface of the light metal substrate. Non-limiting examples of chelating agents can include ethylenediaminetetraacetic acid, ethylenediamine, nitrilotriacetic acid, diethylenetriaminepenta (methylenephosphonic acid), nitrilotris (methylenephosphonic acid) and 1-hydroxyethane-1,1-disphosphonic acid. At the same time, a passivating metal oxide layer may form on the surface of the light metal substrate. In some examples, the transparent passivation layer can have a thickness from about 30 nm to about 3 μm. In certain examples, the transparent passivation layer can be added to the pre-existing surface of the light metal substrate, such that the transparent passivation layer includes additional material added onto the surface of the light metal substrate. In other examples, the passivation layer can involve converting the existing surface of the light metal substrate into a passive layer so that no net addition of material to the pre-existing surface occurs.

### Primer Coating, Optional Base Coating, Top Coating Layers

In some examples, housings described and prepared herein can include a coating (or application of coating), such as by application of a spray coating or electrostatically-applied coating to a surface of the metal. The coating can provide an aesthetic appeal and/or protection to the housing. Spray coating can be used to apply a primer coat, a base coat, a top coat, or a combination thereof. Electrostatic coating can be used to a powder coat. Sprayed coatings can be applied as primer coatings, base coatings, top coatings, etc.

### Primer Coat

In some examples, the primer coating layer can comprise polyurethane, silicone-polyurethane copolymer, polyurethane-polystyrene copolymer, polyurethane based copolymers, polyester, epoxy, epoxy-polyester, and combinations thereof.

A primer coat, for example, can include a polyester, polyurethane, or a combination thereof that can be applied to a surface of the metal substrate. The primer coat can be cured by baking the surface at a temperature that can range from about 60° C. to about 80° C. for a time period that can range from about 15 minutes to about 40 minutes. The primer coat can be applied at a thickness that can range from about 5 μm to about 20 μm.

The primer coating layer may comprise at least one of a polyurethane or a filler selected from carbon black, titanium dioxide, clay, mica, talc, barium sulfate, calcium carbonate, a synthetic pigment, a metallic powder, aluminum oxide, carbon nanotubes (CNTs), graphene, graphite, or an organic powder or a combination thereof. The primer may comprise a polyurethane and a filler. In an example, the primer coating layer is a polyester polyurethane.

The primer coating layer may have a thickness of less than about 25 μm, or less than about 20 μm, or less than about 15 μm, or less than about 12.5 μm, or less than about 10 μm, or less than about 8 μm, or less than about 5 μm. The thickness of the primer coating layer can be measured after it has been printed using, for example, a micrometre screw gauge or scanning electron microscope (SEM).

In some examples the primer coating layer is thicker than the base coating layer or the based coating layer.

### Base Coat

In some examples, the base coating layer can comprise polyacrylic, polyurethane, silicone-polyurethane copolymer, polyurethane-polystyrene copolymer, polyurethane based copolymers, polyester, epoxy, epoxy-polyester, and combinations thereof.

A base coat can include polyester, polyurethane and polyurethane copolymers with pigments including carbon black, titanium dioxide, clay, mica, talc, barium sulfate, calcium carbonate, synthetic pigment, metallic powder, aluminum oxide, organic powder, inorganic powder, plastic bead, color pigment, dye, or any combination thereof. The base coat can be cured by baking the surface of the metal substrate at a temperature ranging from about 60° C. to about 80° C. for a time period ranging from about 15 minutes to about 40 minutes. The base coat can be applied at a thickness that can range from about 10 μm to about 20 μm.

In some, examples, a base coat can include a polyester, a polyurethane, or a copolymer thereof. In one example, a top coat can include a polyurethane, a polyacrylic or polyacrylate, a urethane, an epoxy, or a copolymer thereof. The paint coating can be any number of colors and can be transparent, semi-transparent, or opaque.

In some examples, the base coating layer may comprise polyurethane-containing pigments. The base coating, layer may further comprise at least one of carbon black, titanium dioxide, clay, mica, talc, barium sulfate, calcium carbonate, synthetic pigment, metallic powder, aluminum oxide, an organic powder, an inorganic powder, graphene, graphite, plastic beads, a color pigment or a dye. The organic powder may, for example, be an acrylic, a polyurethane, a polyamide, a polyester or an epoxide. In some examples, the base coating layer may further comprise a component selected from barium sulfate, talc, a dye and a color pigment. In one example, the base coating layer comprises a color pigment or a dye. In some examples, the base coating layer may further comprise a heat resistant material, such as a silica aerogel. The base coating layer can comprise a heat resistant material and a component as described above.

In some examples, the base coating layer has a thickness of less than about 25 μm, or less than about 20 μm, or less than about 15 μm, or less than about 12.5 μm, or less than about 10 μm, or less than about 8 μm, or less than about 5 μm. The thickness of the prime coating layer can be measured after it has been printed using, for example, a micrometre screw gauge or SEM.

### Top Coat

In some examples, the top coating layer comprises acrylate epoxy, acrylate urethane, acrylate polyether, acrylate polyester, polyester, polyurethane, and combinations thereof.

In some examples, the top coating layer comprises nanosized and/or coarse high refractive index pigments having a Mohs hardness of about ≥5, or of about ≥6, or of about ≥7, or of about ≥8, or of about ≥8, or of about ≥9, or of about ≥10.

A top coat can include a polyurethane coat and/or an ultra-violet coat. A polyurethane coat can include a polyurethane, a polyurethane copolymer, or both a polyurethane and a polyurethane copolymer. The polyurethane coat can be cured at a temperature that can range from about 60° C. to about 80° C. for a time period that can range from about 15 minutes to about 40 minutes. An ultra-violet coat can include a polyacrylic, a polyurethane, a urethane acrylate, an acrylic acrylate, an epoxy acrylate, or any combinations thereof. The ultra-violet coat can be cured at temperature that can range from about 50° C. to about 60° C., for a time period of from about 10 minutes to about 15 minutes, followed by UV exposure to a light having an energy ranging from about 700 mJ/cm² to about 1,200 mJ/cm² for from about 10 seconds to about 30 seconds. The polyurethane coat, the ultra-violet coat, or both the polyurethane coat and the ultra-violet coat can be independently applied at a thickness that can range from about 10 μm to about 25 μm.

In some examples, the top coating layer is a heat-sensitive or UV-curable resin. The top coating layer may comprise at least one of a polyacrylic resin, a polyurethane resin or polymer, a urethane acrylate resin, an acrylic acrylate resin or an epoxy acrylate resin, or a combination thereof.

In some examples, the top coating layer has a thickness of less than about 25 μm, or less than about 20 μm, or less than about 15 μm, or less than about 12.5 μm, or less than about 10 μm, or less than about 8 μm, or less than about 5 μm. The thickness of the prime coating layer can be measured after it has been printed using, for example, a micrometre screw gauge or SEM.

### Hydrophobic Coating Layer

In some examples, the hydrophobic coating layer is selected from the group consisting of silanes, fluorinated olefin-based polymers, specialty fluoroacrylates, fluorosilicone acrylates, fluorourethanes, perfluoropolyethers, perfluoropolyoxetanes, fluorotelomers, polytetrafluoroethylene, polyvinylidenefluouride, fluorosiloxane, fluoro UV polymers, and combinations thereof.

The hydrophobic coating can have a thickness of from about 10 nm to about 100 nm, or from about 15 nm to about 95 nm, or from about 20 nm to about 90 nm, or from about 25 nm to about 85 nm, or from about 30 nm to about 80 nm, or from about 35 nm to about 75 nm, or from about 40 nm to about 70 nm.

In some examples, the hydrophobic coating can comprise C7 or, higher hydrophobic fluoropolymers, C6 or lower fluorotelomers, UV fluoropolymers, or combinations thereof.

In some examples, the hydrophobic coating comprises a fluoropolymer selected from the group consisting of fluoroacrylates, fluorosilicone acrylates, fluorourethanes, perfluoropolyethers, perfluoropolyoxetanes, polytetrafluoroethylene (PTFE), polyvinylidenefluourides (PVDF), fluorosiloxanes, or combinations thereof.

In some examples, the hydrophobic coating can be cured by heating to a temperature of from about 70° C. to about 180° C. for from about 30 minutes to about 180 minutes.

In some examples, radiation energy can be applied to the hydrophobic coating to cure the fluoropolymers. In certain examples, the hydrophobic coating can be cured by applying UV radiation. Curing can include exposing the coating to radiation energy at an intensity from about 500 mJ/cm² to about 2,000 mJ/cm² or from about 700 mJ/cm² to about 1,300 mJ/cm². The layer can be exposed to the radiation energy for a curing time from about 5 seconds to about 30 seconds, or from about 10 seconds to about 30 seconds. In other examples, curing can include heating at a temperature from about 50° C. to about 80° C. or from about 50° C. to about 60° C. or from about 60° C. to about 80° C. The hydrophobic coating can be heated for a curing time from about 5 minutes to about 40 minutes, or from about 5 minutes to about 10 minutes, or from about 20 minutes to about 40 minutes, in some examples.

### Definitions

It is noted that, as used in this specification and the appended claims, the singular forms “a,” “an,” and “the” include plural referents unless the content clearly dictates otherwise.

The term “about” as used herein, when referring to a numerical value or range, allows for a degree of variability in the value or range, for example, within 5% or other reasonable added range breadth of a stated value or of a stated limit of a range. The term “about” when modifying a numerical range is also understood to include the exact numerical value indicated, e.g., the range of about 1 wt % to about 5 wt % includes 1 wt % to 5 wt % as an explicitly supported sub-range.

As used herein, “colorant” can include dyes and/or pigments.

As used herein, “dye” refers to compounds or molecules that absorb electromagnetic radiation or certain wavelengths thereof. Dyes can impart a visible color to an ink if the dyes absorb wavelengths in the visible spectrum.

As used herein, “pigment” generally includes pigment colorants, magnetic particles, aluminas, silicas, and/or other ceramics, organo-metallics or other opaque particles, whether or not such particulates impart color. Thus, though the present description primarily exemplifies the use of pigment colorants, the term “pigment” can be used more generally to describe pigment colorants and other pigments such as organometallics, ferrites, ceramics, etc. In one specific example, however, the pigment is a pigment colorant.

As used herein, a plurality of items, structural elements, compositional elements, and/or materials may be presented in a common list for convenience. However, these lists should be construed as though the individual members of the list are individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, and also to include all the individual numerical values or sub-ranges encompassed within that range as if individual numerical values and sub-ranges are explicitly recited. For example, a layer thickness from about 0.1 μm to about 0.5 μm should be interpreted to include the explicitly recited limits of 0.1 μm to 0.5 μm, and to include thicknesses such as about 0.1 μm and about 0.5 μm, as well as subranges such as about 0.2 μm to about 0.4 μm, about 0.2 μm to about 0.5 μm, about 0.1 μm to about 0.4 μm etc.

The following illustrates an example of the present disclosure. However, it is to be understood that the following is illustrative of the application of the principles of the present disclosure. Numerous modifications and alternative compositions, methods, and systems may be devised without departing from the spirit and scope of the present disclosure. The appended claims are intended to cover such modifications and arrangements.

What is claimed is:

1. A cover for an electronic device comprising:
a substrate comprising a metal:
a passivation layer or a micro-arc oxidation layer deposited on at least one surface of the substrate;
a primer coating layer on the passivation layer or the micro-arc oxidation layer;
an optional base coating layer on the primer coating layer;
a top coating layer on the optional base coating layer or on the primer coating layer; and
a hydrophobic coating layer.

2. The cover of claim 1, wherein the metal comprises aluminum and aluminum alloys, titanium and titanium alloys, stainless steel, magnesium and magnesium alloys, aluminum and aluminum alloys, lithium and lithium alloys, and combinations thereof.

3. The cover of claim 1, wherein the top coating layer comprises acrylate epoxy, acrylate urethane, acrylate polyether, acrylate polyester, polyester, polyurethane, and combinations thereof.

4. The cover of claim 1, wherein the top coating layer comprises nanosized and/or coarse high refractive index pigments having a Mohs hardness of about ≥5.

5. The cover of claim 1, wherein the primer coating layer and the base coating layer can comprise polyurethane, silicone-polyurethane copolymer, polyurethane-polystyrene copolymer, polyurethane based copolymers, polyester, epoxy, epoxy-polyester, and combinations thereof.

6. The cover of claim 1, wherein the hydrophobic coating layer has a thickness of from about 10 nm to about 100 nm.

7. The cover of claim 1, wherein the primer coating layer has a thickness of from about 5 μm to about 20 μm.

8. The cover of claim 1, wherein the passivation layer has a thickness of from about 1 μm to about 5 μm.

9. The cover of claim 1, wherein the micro-arc oxidation layer has a thickness of from about 3 μm to about 15 μm.

10. The cover of claim 1, wherein the hydrophobic coating layer is selected from the group consisting of silanes, fluorinated olefin-based polymers, specialty fluoroacrylates, fluorosilicone acrylates, fluorourethanes, perfluoropolyethers, perfluoropolyoxetanes, fluorotelomers, polytetrafluoroethylene, polyvinylidenefluouride, fluorosiloxane, fluoro UV polymers, and combinations thereof.

11. An electronic device comprising:
an electronic component; and
a cover enclosing the electronic component, the cover comprising:
a substrate comprising a metal;
a passivation layer or a micro-arc oxidation layer deposited on at least one surface of the substrate;
a primer coating layer on the passivation layer or the micro-arc oxidation layer;
an optional base coating layer on the primer coating layer;
a top coating layer on the optional base coating layer or on the primer coating layer; and
a hydrophobic coating layer.

12. The electronic device of claim 11, wherein the electronic device is a laptop, a desktop computer, a keyboard, a mouse, a smartphone, a tablet, monitor, a television screen, a speaker, a game console, a video player, an audio player, or a combination thereof.

13. The electronic device of claim 11, wherein:
the hydrophobic coating layer is selected from the group consisting of silanes, fluorinated olefin-based polymers, specialty fluoroacrylates, fluorosilicone acrylates, fluorourethanes, perfluoropolyethers, perfluoropolyoxetanes, fluorotelomers, polytetrafluoroethylene, polyvinylidenefluouride, fluorosiloxane, fluoro UV polymers, and combinations thereof; and
the hydrophobic coating layer has a thickness of from about 10 nm to about 100 nm.

14. A method of making a cover for an electronic device comprising:
applying a passivation layer or forming a micro-arc oxidation layer deposited on at least one surface of a substrate;
applying a primer coating layer on the passivation layer or the micro-arc oxidation layer;
applying an optional base coating layer on the primer coating layer;
applying a top coating layer on the optional base coating layer or on the primer coating layer; and
applying a hydrophobic coating layer on the top coating layer.

15. The method of claim 14, wherein the substrate comprises at least one metal, wherein the metal comprises aluminum and aluminum alloys, titanium and titanium alloys, stainless steel, magnesium and magnesium alloys, aluminum and aluminum alloys, lithium and lithium alloys, and combinations thereof.
